(19) United States
(12) Patent Application Publication
(10) Pub. No.: US 2010/0018345 A1
(43) Pub. Date: Jan. 28, 2010

(54) INTEGRALLY CAST BICYCLE CHAIN TRANSMISSION

(75) Inventor: Matthieu LANZ, Nevers (FR)

Correspondence Address: YOUNG & THOMPSON, 209 Madison Street, Suite 500, Alexandria, VA, 22314, US

(73) Assignee: LOOK CYCLE INTERNATIONAL, Nevers (FR)

(21) Appl. No.: 12/505,559

(22) Filed: Jul. 20, 2009

(30) Foreign Application Priority Data
Jul. 23, 2008 (FR) 08.04195

(51) Int. Cl. B62M 3/00

(52) U.S. Cl. 74/594.1

(57) ABSTRACT

The chain transmission includes a crank connected to a second crank by an axle of the chain transmission while forming one piece of a single support. The chain transmission axle is housed in a chain transmission tube with the interposition of two bearings arranged around the axle of the chain transmission near the ends of the latter in order to allow rotation of the chain transmission axle in the chain transmission tube. A large chain drive sprocket wheel is located near one of the ends of the chain transmission axle and rotates concomitantly with the latter. The cranks and the chain transmission axle are made of a composite material or a hollow lightweight alloy. A first and second intermediate bushing made of an abrasion-resistant material are attached to the chain transmission axle near one respective end of the latter to receive a respective bearing.

This invention relates to a bicycle chain transmission, and in particular to an integrally cast chain transmission, as well as a bicycle provided with such a chain transmission.

Bicycle chain transmissions comprise an axle of the chain transmission, two cranks attached to the ends of the axle, and a large sprocket wheel that rotates concomitantly with the axle of the chain transmission. The cranks extend in opposite directions and on their free end comprise means of attachment of a pedal axle. These attachment means are generally composed of a single tapped hole that receives the threaded end of the pedal axle.

The axle of the chain transmission can be accommodated in the tube of the chain transmission of a bicycle frame with interposition of bearings located on the ends of the axle of the chain transmission and thus forming a means allowing rotation of the axle of the chain transmission within the tube of the chain transmission.

There are integrally cast bicycle chain transmissions, among others, designed to obtain better precision of the relative location of the different parts of a bicycle chain transmission. In a classic integrally cast chain transmission, the axle of the chain transmission and the two cranks together form a single metal piece that overall has the shape of a “Z.”

Such an integrally cast bicycle chain transmission is known from the U.S. Pat. No. 4,418,584 that describes a bicycle chain transmission whose chain transmission axle and the cranks are manufactured in a single piece. This document relates especially to the manner of mounting the large sprocket wheel on the bicycle chain transmission for purposes of easier replacement if this large sprocket wheel is damaged.

Another example of an integrally cast bicycle chain transmission is described in the U.S. Pat. No. 4,545,691 that shows a similar integrally cast chain transmission in which the inner bushings of the two bearings are connected to one another by a sleeve.

Since the general trend is to make all the components of the bicycle as light as possible while ensuring good mechanical strength, it would be advantageous to be able to use an integrally cast chain transmission that is composed entirely of composite material. Carbon, however, since it has little resistance to abrasion, makes direct support of the bearings essentially impossible, which bearings, moreover, must sometimes be removed and replaced for maintenance operations.

For this reason, while a structure that is lighter due to composite materials is desirable, to date it has been necessary to be restricted to multipart bicycle chain transmissions, of which mainly the cranks are made of composite material. However, in this case it is impossible not to use metal inserts in the ends to ensure good attachment of the cranks on the axle of the chain transmission, most often using splines. The point is to make the assembly lighter, but the inserts necessarily add weight, entail added manufacturing costs and make the chain transmission complex in order to ensure good mechanical strength.

Another approach to making the bicycle chain transmission lighter would be to use a hollow lightweight alloy, but to date there has likewise been the limitation to multipart bicycle chain transmissions, of which mainly the cranks are made of a hollow lightweight alloy. Such a chain transmission is known from the document EP 0 850 825.

This limitation is probably due to the fact that an integrally cast bicycle chain transmission with a single support of a hollow alloy would engender the problem of rigidity of the thin walls of the axle of the chain transmission that at the location of the bearings would run the risk of being deformed under stress. For this reason, an integrally cast bicycle chain transmission has not yet been envisioned.

The purpose of the invention is to solve these problems by suggesting a solution that allows the use of an integrally cast bicycle chain transmission made of a composite material or a hollow lightweight alloy in order to make the chain transmission assembly significantly lighter. In the former case, it is necessary to shed a significant number of connecting pieces such as screws, nuts or washers, as well as the corresponding inserts. In the latter case, the new design yields improved rigidity of the entire assembly and allows use of a maximum of the available volume while at the same time the walls can be made relatively thin to keep the weight down.

The object of the invention is an integrally cast bicycle chain transmission comprising a first crank connected to a second crank by an axle of the chain transmission by forming with the latter one piece of a single support, the chain transmission axle being able to be housed in a chain transmission tube of a bicycle frame with the interposition of a first bearing and a second bearing arranged around the axle of the chain transmission near the ends of the latter in order to allow rotation of the chain transmission axle within said chain transmission tube, a large chain drive sprocket wheel being located near one of the ends of the chain transmission axle and rotating concomitantly with the latter, characterized in that a first and a second intermediate bushing of a material that has increased rigidity and that is resistant to abrasion are attached to the chain transmission axle near one respective end of the latter to receive the respective bearing.

According to other characteristics of the invention:
the material of the chain transmission is a composite material;
said intermediate bushings are attached to the chain transmission axle by polymerization of said composite material of the chain transmission axle following expansion of said material;
the material of the chain transmission is a hollow lightweight alloy;
said intermediate bushings are attached to the chain transmission axle by expansion of the alloy when the chain transmission is being shaped;
said intermediate bushing that is farthest away from the large sprocket wheel on its end pointed toward the outside is provided with threading that can work with a tapped assembly bushing;
said assembly bushing is split to receive in its slot a shim that during assembly facilitates screwing of the assembly bushing onto the threading of the intermediate bushing;
said assembly bushing comprises an attachment hole extending perpendicular to the slot of the assembly bushing on either side of the latter to receive an attachment and tightening screw;
the chain transmission axle has a central concave recess that facilitates assembly of the chain transmission to the frame;
said large sprocket wheel is composed of a round toothed chain wheel supported by a chain wheel carrier, and said chain wheel carrier is part of said one piece of a single support;
the chain wheel carrier is in the shape of a star whose arms originate directly on the end of the first crank connected to the axle of the chain transmission by being centered on the axis A-A of the latter;
said first bearing is immobilized on the axle of the chain transmission using two stop rings arranged on either side of the bearing and fitting into corresponding grooves provided on the axle of the chain transmission;
the abrasion-resistant material with increased rigidity of the first and second intermediate bushings is a lightweight alloy.

Another object of the invention is a bicycle provided with a chain transmission as defined above.

Other characteristics and advantages of the invention will become apparent from the following description of one nonlimiting embodiment of the invention with reference to the attached figures in which:

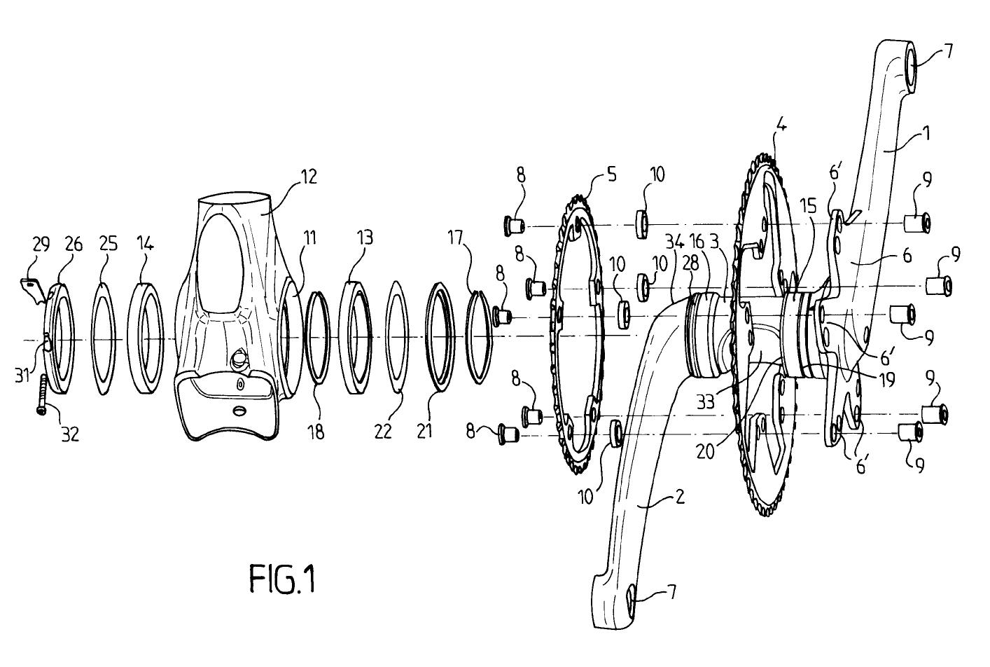

FIG. 1 is an exploded perspective view of an integrally cast bicycle chain transmission according to the invention;

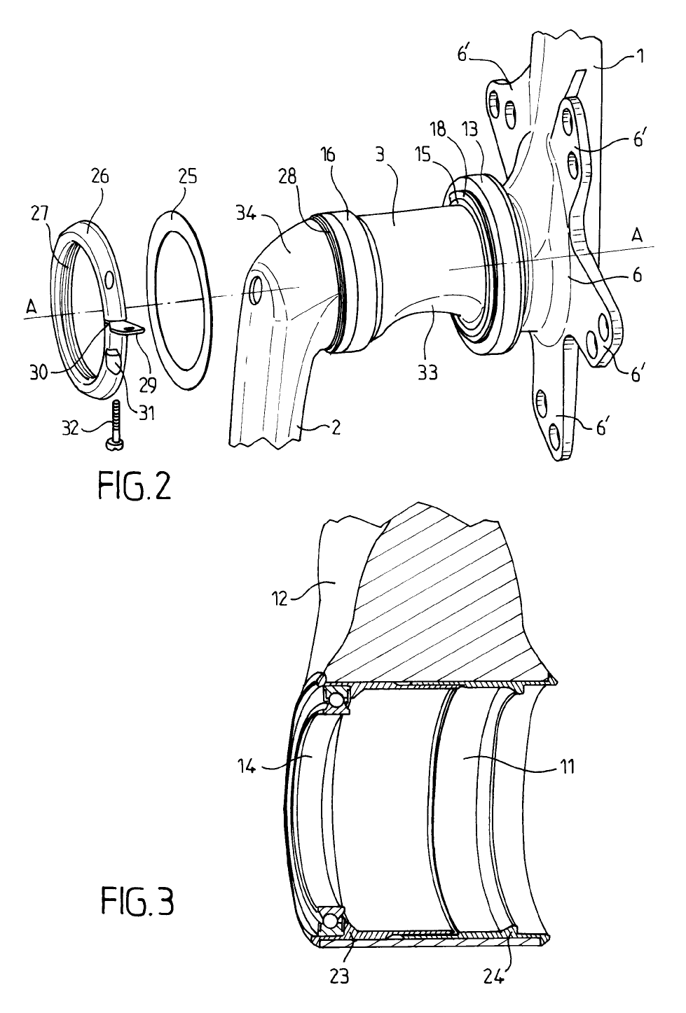

FIG. 2 is a partial perspective view of the bicycle chain transmission with a subassembly premounted before its assembly onto the tube of the chain transmission of a bicycle frame;

FIG. 3 is a partial perspective view of a tube of a chain transmission prepared with the installation of a bearing before receiving the bicycle chain transmission of FIG. 2;

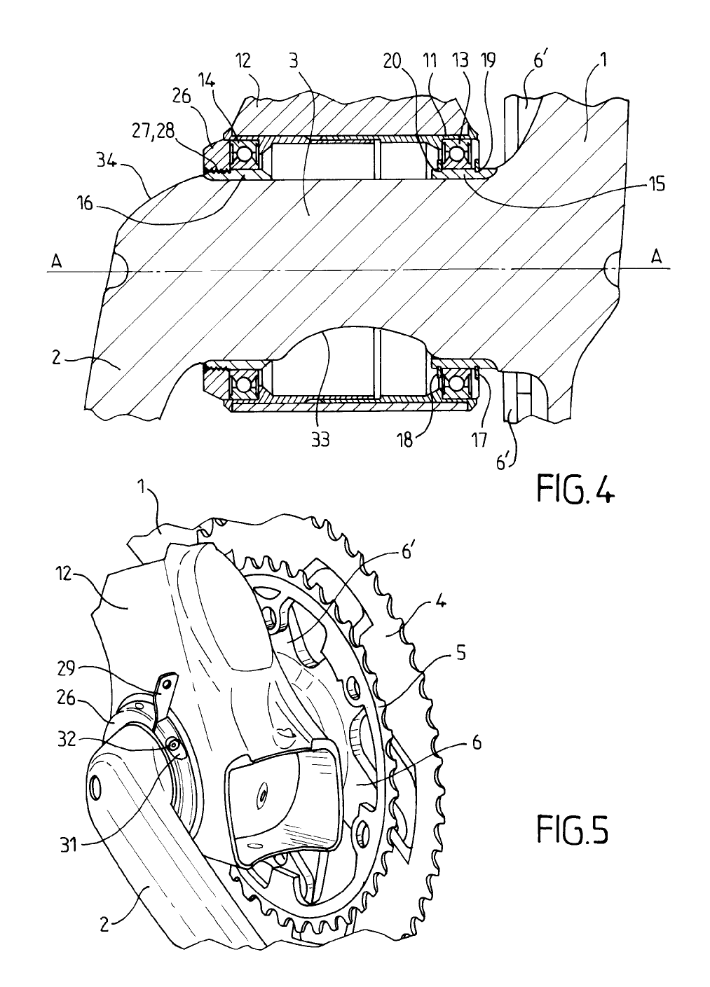

FIG. 4 is a partial cutaway view along line A-A of FIG. 2;

FIG. 5 is a partial perspective view illustrating the last phase of assembly of the bicycle chain transmission with the tube of the chain transmission of FIG. 3;

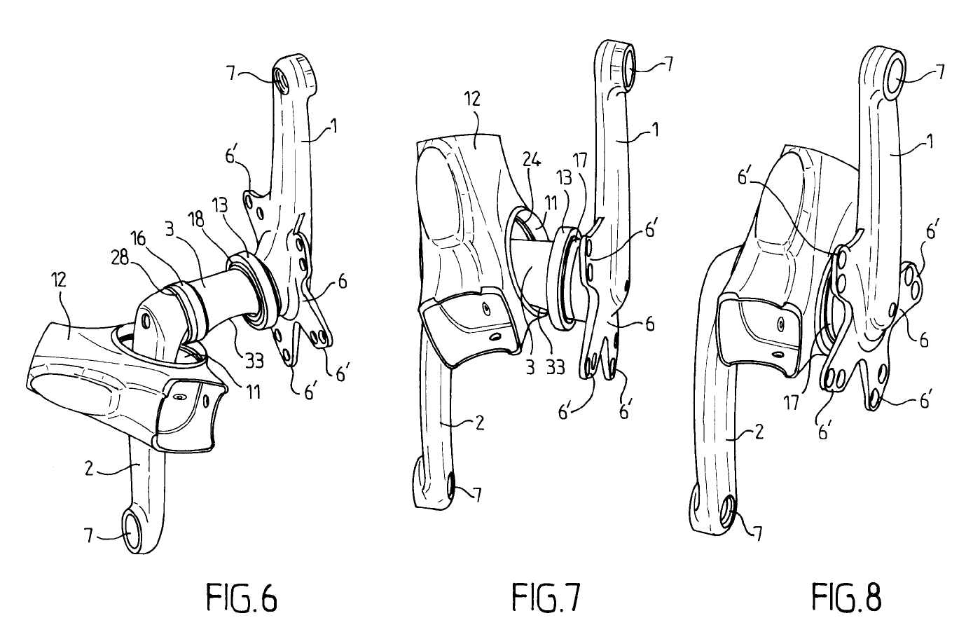

FIGS. 6 to 8 show three consecutive phases of assembly of the bicycle chain transmission with the tube of the chain transmission.

In the figures, identical or equivalent components will have the same reference numbers.

FIG. 1 shows a bicycle chain transmission according to the invention, comprising a first crank 1 connected to a second crank 2 by the axle of the chain transmission 3. The cranks 1 and 2 extend in opposite directions from one respective end of the axle of the chain transmission 3. The cranks 1 and 2 can bear on their end a respective pedal (not shown), of which the threaded axle can be screwed into a tapped hole 7 on the end of the crank.

In the illustrated example, the chain transmission comprises two large sprocket wheels composed of a first, round, toothed chain wheel 4 and a second, round, toothed chain wheel 5 attached to a chain wheel carrier 6 in the shape of a star that rotates concomitantly with the axle of the chain transmission 3. The teeth of the first and second chain wheels 4, 5 can work with a drive chain (not shown) that in turn drives the rear wheel (not shown) of a bicycle in rotation.

This bicycle chain transmission is thus made with double chain wheels, i.e., it comprises a first toothed chain wheel 4 that is larger than the second toothed chain wheel 5 to obtain a higher gear for using the bicycle downhill or on flat terrain, whereas the second chain wheel 5 that is smaller makes it possible to climb hills more easily or to start out more easily.

The first and second chain wheels 4, 5 are attached to the arms 6′ of the chain wheel carrier 6 using fasteners such as screws 8 that pass through the holes provided in the chain wheels and in the chain wheel carrier for working with nuts 9, with the interposition of spacers 10 between the first and second chain wheels.

The axle of the chain transmission 3 can be housed in a tube of the chain transmission 11 of a bicycle frame 12, of which only the part relating to the invention is shown in the figures. To allow rotation of the axle of the chain transmission 3 within the chain transmission tube 11, a first bearing 13 and a second bearing 14 connect the chain transmission axle to the chain transmission tube while being arranged around the chain transmission axle near the ends of the latter. This mounting will be presented in detail below.

According to one aspect of the invention, the first and second cranks 1, 2 as well as the axle of the chain transmission 3 are made of a composite material. According to another aspect of the invention, the first and the second cranks 1, 2 as well as the chain transmission axle 3 are made of a hollow lightweight alloy, for example formed by hydroforming.

According to one critical characteristic of the invention, a first and a second intermediate bushing 15, 16 made of a material with increased rigidity and with abrasion resistance are attached to the axle of the chain transmission 3 near one respective end of the latter to accommodate the respective bearing 13, 14 by a close fit.

To advantageously make the assembly lighter, the material with increased rigidity and with abrasion resistance of the first and second intermediate bushings 15, 16 is preferably a lightweight alloy with the characteristics necessary for good resistance to abrasion.

The intermediate bushings 15, 16 can be attached to the axle of the chain transmission 3 by cementing, or, very advantageously, in the case in which the material of the integrally cast chain transmission is a composite material, they can be attached there by polymerization of the composite material of the axle of the chain transmission following expansion of the material that can be obtained by, for example, inflation with compressed air.

Similarly, in the case in which the material of the integrally cast chain transmission is a lightweight alloy, the intermediate bushings 15, 16 can be attached to the axle of the chain transmission 3 during manufacture of the integrally cast chain transmission, and more exactly the bushings 15, 16 during manufacture are placed on the axle of the chain transmission to be attached by expansion of the alloy during hydroforming.

According to another major characteristic of the invention, the chain wheel carrier 6 is part of the piece of a single support formed by the cranks 1, 2 and the axle of the chain transmission 3. In the embodiment illustrated in the figures, the arms 6′ of the chain wheel carrier 6 originate directly on the end of the first crank 1 that is connected to the axle of the chain transmission 3 by being centered on axis A-A of the latter.

Other components used to assemble the chain transmission with the chain transmission tube 11 of the frame 12 are shown in FIG. 1.

Thus, for assembly purposes, it is advantageous to attach beforehand the first bearing 13 to the chain transmission axle 3 (see FIG. 2) and the second bearing 14 in the chain transmission tube 11 of the frame (see FIG. 3).

The first bearing 13 is immobilized on the axle of the chain transmission 3 using two stop rings 17, 18 arranged on either side of the bearing 13 and fitting into corresponding grooves 19, 20 provided in the axle of the chain transmission. A washer 21 and a seal 22 are placed between the bearing 13 and the stop ring 17 on the side of the chain wheel carrier 6. In this way, a subassembly that is kept in place during assembly is obtained.

The second bearing 14 is attached within the tube of the chain transmission 11 against a first circular stop rib 23, as is illustrated in FIG. 3. A second circular stop rib 24 is provided in the tube of the chain transmission 11, against which subsequently the first bearing 13 must be supported.

Finally, a seal 25 is placed against the outer surface of the second bearing 14 during assembly, and the entire assembly is kept in place using an assembly bushing 26 that comprises tapping 27 that is able to work with a threading 28 provided on the second intermediate bushing 16 on the outside of the latter.

The assembly bushing 26 is preferably split so that it can be more easily screwed into the threading 28 by inserting a shim 29 into the slot 30 of the bushing that keeps it spaced properly, and then the assembly bushing 26 can be easily screwed into the threading 28 of the second intermediate bushing 16 until an assembly that is free but without excessive play is obtained.

FIG. 5 shows the last phase of this assembly, following which the shim 29 is removed after this adjustment, while FIG. 4 shows the relative position of the pieces mounted on the axle of the chain transmission 3.

The assembly bushing 26 for its reliable support advantageously comprises an attachment hole 31 extending perpendicular to the slot 30 of the bushing 26 on either side of the latter to receive a fastening and tightening screw 32. The attachment hole 31 is preferably tapped to work directly with the threading of the screw 32.

To facilitate insertion and relocation of the chain transmission axle 3 within the chain transmission tube 11 during assembly, the chain transmission axle 3 advantageously has a central concave recess 33 so that it does not interfere with assembly of the chain transmission with the frame. This recess 33 can be combined with a convex rounded shape 34 on the part originating from the second crank 2.

Finally, FIGS. 6 to 8 illustrate three consecutive phases of assembly of the chain transmission according to the invention onto a bicycle frame.

Of course, the invention is not limited to the described and illustrated examples, and it is within the capability of one skilled in the art to provide numerous variants without exceeding the scope of the invention.
A-A—Axis of the chain transmission
1—First crank
2—Second crank
3—Axle of the chain transmission
4—First large sprocket wheel
5—Second large sprocket wheel
6—Chain wheel carrier
6′—Arms (of 6)
7—Tapped hole (on the end of 1 and 2)
8—Mounting screw (of 4 and 5)
9—Nut
10—Spacer
11—Tube of the chain transmission
12—Bicycle frame
13—First bearing
14—Second bearing
15—First intermediate bushing
16—Second intermediate bushing
17—Stop ring
18—Stop ring
19—Groove (in 3)
20—Groove (in 3)
21—Washer
22—Seal
23—First circular stop rib (in 11)
24—Second circular stop rib (in 11)
25—Seal
26—Assembly bushing
27—Tapping (in 26)
28—Threading (on 16)
29—Shim
30—Slot
31—Attachment hole (in 26)
32—Attachment and tightening screw
33—Central concave recess
34—Convex rounded shape

1. Integrally cast bicycle chain transmission, comprising a first crank (1) connected to a second crank (2) by an axle of the chain transmission (3), while forming with the latter one piece of a single support, the chain transmission axle (3) being able to be housed in a chain transmission tube (11) of a bicycle frame (12) with the interposition of a first bearing (13) and a second bearing (14), arranged around the axle of the chain transmission (3) near the ends of the latter in order to allow rotation of the chain transmission axle within said chain transmission tube (11), a large chain drive sprocket wheel (4, 5) being located near one of the ends of the chain transmission axle (3) and rotating concomitantly with the latter, characterized in that a first and a second intermediate bushing (15, 16) made of a material that has increased rigidity and that is resistant to abrasion are attached to the chain transmission axle (3) near one respective end of the latter to receive a respective bearing (13, 14).

2. Integrally cast bicycle chain transmission according to claim 1, wherein the material of the chain transmission is a composite material.

3. Integrally cast bicycle chain transmission according to claim 2, wherein said intermediate bushings (15, 16) are attached to the chain transmission axle (3) by polymerization of said composite material of the chain transmission axle following expansion of said material.

4. Integrally cast bicycle chain transmission according to claim 1, wherein the material of the chain transmission is a hollow lightweight alloy.

5. Integrally cast bicycle chain transmission according to claim 4, wherein said intermediate bushings (15, 16) are attached to the chain transmission axle (3) by expansion of the alloy when the chain transmission is being formed.

6. Integrally cast bicycle chain transmission according to claim 1, wherein said intermediate bushing (16) that is farthest away from the large sprocket wheel (4, 5) on its end pointed toward the outside is provided with a threading (28) that can work with a tapped assembly bushing (26).

7. Integrally cast bicycle chain transmission according to claim 6, wherein said assembly bushing (26) is split to receive in its slot (30) a shim (29) that during assembly facilitates screwing of the assembly bushing (26) onto the threading (28) of said intermediate bushing (16).

8. Integrally cast bicycle chain transmission according to claim 7, wherein said assembly bushing (26) comprises an attachment hole (31) extending perpendicular to the slot (30) of the assembly bushing (26) on either side of the latter to receive an attachment and tightening screw (32).

9. Integrally cast bicycle chain transmission according to claim 1, wherein the chain transmission axle (3) has a central concave recess (33) that facilitates assembly of the chain transmission with the frame.

10. Integrally cast bicycle chain transmission according to claim 1, wherein said large sprocket wheel (4, 5) is composed of a round, toothed chain wheel supported by a chain wheel carrier (6), wherein said chain wheel carrier (6) is part of said one piece of a single support (1, 2, 3).

11. Integrally cast bicycle chain transmission according to claim 10, wherein the chain wheel carrier (6) is in the shape of a star whose arms (6′) originate directly on the end of the first crank (1) connected to the chain transmission axle (3) by being centered on the axis A-A of the latter.

12. Integrally cast bicycle chain transmission according to claim 1, wherein said first bearing (13) is immobilized on the axle of the chain transmission (3) using two stop rings (17, 18) arranged on either side of the bearing (13) and fitting into corresponding grooves (19, 20) provided on the axle of the chain transmission (3).

13. Integrally cast bicycle chain transmission according to claim 1, wherein the abrasion-resistant material with increased rigidity of the first and second intermediate bushings (15, 16) is a lightweight alloy.

14. Bicycle with an integrally cast bicycle chain transmission, wherein the chain transmission has the characteristics of claim 1.

15. Integrally cast bicycle chain transmission according to claim 2, wherein said intermediate bushing (16) that is farthest away from the large sprocket wheel (4, 5) on its end pointed toward the outside is provided with a threading (28) that can work with a tapped assembly bushing (26).

16. Integrally cast bicycle chain transmission according to claim 2, wherein the chain transmission axle (3) has a central concave recess (33) that facilitates assembly of the chain transmission with the frame.

17. Integrally cast bicycle chain transmission according to claim 2, wherein said large sprocket wheel (4, 5) is composed of a round, toothed chain wheel supported by a chain wheel carrier (6), wherein said chain wheel carrier (6) is part of said one piece of a single support (1, 2, 3).

18. Integrally cast bicycle chain transmission according to claim 2, wherein said first bearing (13) is immobilized on the axle of the chain transmission (3) using two stop rings (17, 18) arranged on either side of the bearing (13) and fitting into corresponding grooves (19, 20) provided on the axle of the chain transmission (3).

19. Integrally cast bicycle chain transmission according to claim 2, wherein the abrasion-resistant material with increased rigidity of the first and second intermediate bushings (15, 16) is a lightweight alloy.
